(19) United States
(12) Patent Application Publication
(10) Pub. No.: US 2025/0392933 A1
(43) Pub. Date: Dec. 25, 2025

(54) DATA-EFFICIENT UPDATING FOR CHANNEL CLASSIFICATION

(71) Applicants: NOKIA SOLUTIONS AND NETWORKS OY, Espoo (FI); NOKIA SHANGHAI BELL CO., LTD., Shanghai (CN)

(72) Inventors: Chenhui YE, Shanghai (CN); Heng PAN, Shanghai (CN); Muhammad Ikram ASHRAF, Espoo (FI); Athul PRASAD, Naperville, IL (US); István Zsolt KOVÁCS, Aalborg (DK)

(21) Appl. No.: 18/880,681

(22) PCT Filed: Sep. 7, 2022
(86) PCT No.: PCT/CN2022/117664

§ 371 Date: Jan. 2, 2025

(30) Foreign Application Priority Data
Jul. 15, 2022 (WO) PCT/CN2022/105916

(51) Int. Cl. H04W 24/08; H04W 64/00

(52) U.S. Cl. CPC H04W 24/08; H04W 64/00

(57) ABSTRACT

Example embodiments of the present disclosure relate to data-efficient updating for channel classification. A device determines an importance level of channel measurement information about a communication channel for updating a classification model, the classification model configured to determine an estimated classification result of the communication channel based on the channel measurement information. In accordance with a determination that the importance level of the channel measurement information exceeds an importance threshold for the classification model, the device obtains a ground-truth classification result for the communication channel. The device causes the classification model to be updated based at least in part on the channel measurement information and the ground-truth classification result.

### CROSS-REFERENCE TO RELATED APPLICATIONS

This application claims the benefit of International Patent Application No. PCT/CN2022/105916, filed on Jul. 15, 2022, entitled “ON-DEMAND LABELLING FOR CHANNEL CLASSIFICATION TRAINING”, which is hereby incorporated by reference in its entirety.

### FIELD

Embodiments of the present disclosure generally relate to the field of telecommunication and in particular, to a method, device, apparatus and computer readable storage medium for data-efficient updating for channel classification.

### BACKGROUND

Location-awareness is a fundamental aspect of wireless communication networks and will enable a myriad of location-enabled services in different applications. The integration and utilization of location information in day-to-day applications will grow significantly as the technology develops.

Many positioning technologies that depend on techniques such time of arrival (TOA), time difference of arrival (TDOA) and angle of arrival (AOA) require light-of-sight (LOS) propagation between a reference point (such as a network device) and a mobile device to be positioned. However, as for non-line-of-sight (NLOS) propagation cases in indoor/outdoor environments, positioning accuracy deteriorates remarkably due to incapability in identifying reflected multipath radio frequency (RF) propagations from diverse arriving angles with diverse delay spreads. Artificial intelligence (AI) algorithms, on the other hand, is intrinsically superior in terms of accuracy and efficiency for fingerprint styled positioning inference regardless of LOS or NLOS. Therefore, classifying the channel propagation is important at least due to its impact on choosing positioning approaches.

### SUMMARY

The scope of protection sought for various embodiments of the invention is set out by the independent claims. The embodiments/examples and features, if any, described in this specification that do not fall under the scope of the independent claims are to be interpreted as examples useful for understanding various embodiments of the invention.” Please note that the term “embodiments” or “examples” should be adapted accordingly to the terminology used in the application, i.e., if the term “examples” is used, then the statement should talk of “examples” accordingly, or if the term “embodiments” is used, then the statement should talk of “embodiments” accordingly.

Embodiments that do not fall under the scope of the claims, if any, are to be interpreted as examples useful for understanding various embodiments of the disclosure.

In a first aspect, there is provided a device. The device comprises at least one processor; and at least one memory storing instructions that, when executed by the at least one processor, cause the first device at least to perform: determining an importance level of channel measurement information about a communication channel for updating a classification model, the classification model configured to determine an estimated classification result of the communication channel based on the channel measurement information; in accordance with a determination that the importance level of the channel measurement information exceeds an importance threshold for the classification model, obtaining a ground-truth classification result for the communication channel; and causing the classification model to be updated based at least in part on the channel measurement information and the ground-truth classification result.

In a second aspect, there is provided a method. The method comprises: determining an importance level of channel measurement information about a communication channel for updating a classification model, the classification model configured to determine an estimated classification result of the communication channel based on the channel measurement information; in accordance with a determination that the importance level of the channel measurement information exceeds an importance threshold for the classification model, obtaining a ground-truth classification result for the communication channel; and causing the classification model to be updated based at least in part on the channel measurement information and the ground-truth classification result.

In a third aspect, there is provided an apparatus. The apparatus comprises: means for determining an importance level of channel measurement information about a communication channel for updating a classification model, the classification model configured to determine an estimated classification result of the communication channel based on the channel measurement information; means for in accordance with a determination that the importance level of the channel measurement information exceeds an importance threshold for the classification model, obtaining a ground-truth classification result for the communication channel; and means for causing the classification model to be updated based at least in part on the channel measurement information and the ground-truth classification result.

In a fourth aspect, there is provided a computer readable medium. The computer readable medium comprises instructions stored thereon for causing an apparatus to perform at least the method according to the second aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a flowchart of a process for data-efficient updating of a classification model according to some example embodiments of the present disclosure;

FIG. 3 illustrates an example signaling flow for communication according to some example embodiments of the present disclosure;

FIG. 4 illustrates an example signaling flow for communication according to some example embodiments of the present disclosure;

FIG. 5 illustrates a flowchart of a process for determining an uncertainty level according to some example embodiments of the present disclosure;

FIG. 6A illustrates an example of a classification model and reference classification models generated therefrom according to some example embodiments of the present disclosure;

FIG. 6B illustrates an example of a classification model and reference classification models generated therefrom according to some further example embodiments of the present disclosure;

FIG. 7 illustrates model performance gain by some example embodiments of the present disclosure relative to a traditional model training approach;

FIG. 8 illustrates a flowchart of a process for determining an uncertainty level according to some further example embodiments of the present disclosure;

FIG. 9A illustrates another example of a classification model according to some further example embodiments of the present disclosure;

FIG. 9B illustrates a further example of a classification model according to some further example embodiments of the present disclosure;

FIGS. 10A-10B illustrate model performance gains by some example embodiments of the present disclosure relative to a traditional model training approach;

FIG. 11 illustrates a simplified block diagram of an apparatus that is suitable for implementing example embodiments of the present disclosure; and

FIG. 12 illustrates a block diagram of an example computer readable medium in accordance with some example embodiments of the present disclosure.

Throughout the drawings, the same or similar reference numerals represent the same or similar element. Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

As used herein, the term “model” is referred to as an association between an input and an output learned from training data, and thus a corresponding output may be generated for a given input after the training. The generation of the model may be based on machine learning (ML) techniques. Machine learning techniques may also be referred to as artificial intelligence (AI) techniques. In general, a machine learning model can be built, which receives input information and makes predictions based on the input information. For example, a classification model may predict a category of input information among a predetermined number of categories. As used herein, “model” may also be referred to as “machine learning model”, “learning model”, “machine learning network”, or “learning network,” which are used interchangeably herein.

Deep learning (DL) is one of machine learning algorithms that processes the input and provides the corresponding output using a plurality of layers of processing units. A neural network (NN) model is an example of a deep learning-based model. The neural network can process an input to provide a corresponding output, and usually includes an input layer, an output layer, and one or more hidden layers between the input layer and the output layer. The neural network used in deep learning usually includes a large number of hidden layers to increase the depth of the network. The layers of the neural network are connected in order, so that the output of a preceding layer is provided as the input of a next layer, where the input layer receives the input of the neural network, and the output of the output layer is regarded as a final output of the neural network. Each layer of the neural network includes one or more nodes (also referred to as processing nodes or neurons), each of which processes input from the preceding layer.

Generally, model lifecycle management may usually include three stages, i.e., a training stage, a validation stage, and an application stage (also referred to as an inference stage). At the training stage, a given machine learning model may be trained (or optimized) iteratively using a great amount of training data until the model can obtain, from the training data, consistent inference similar to those that human intelligence can make. During the training, a set of parameter values of the model is iteratively updated until a training objective is reached. Through the training process, the machine learning model may be regarded as being capable of learning the association between the input and the output (also referred to an input-output mapping) from the training data. At the validation stage, a validation input is applied to the trained machine learning model to test whether the model can provide a correct output, so as to determine the performance of the model. Generally, the validation stage may be considered as a step in a training process, or may be omitted in some cases. At the inference stage, the resulting machine learning model may be used to process a real-world model input based on the set of parameter values obtained from the training process and to determine the corresponding model output. In some cases, a retraining or updating stage may be included in the model lifecycle management, to enable the model evolved to have better performance.

### EXAMPLE ENVIRONMENT

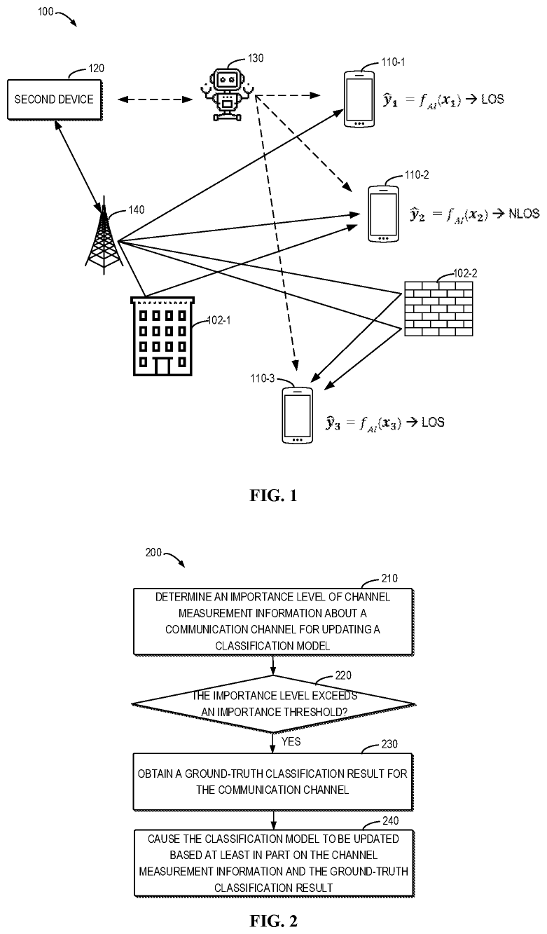

FIG. 1 illustrates an example communication environment 100 in which example embodiments of the present disclosure can be implemented. In the communication environment 100, a plurality of communication devices are involved, including one or more first devices 110-1, 110-2, and 110-3, a second device 120, a third device 130, and a fourth device 140. For the purpose of discussion, the first devices 110-1, 110-2, and 110-3 are collectively or individually referred to as first devices 110.

It is to be understood that the number of devices and their connections shown in FIG. 1 are only for the purpose of illustration without suggesting any limitation. The communication environment 100 may include any suitable number of devices adapted for implementing embodiments of the present disclosure. Although not shown, it would be appreciated that one or more additional devices may be involved in the communication environment 100.

Communications in the communication environment 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

In the communication environment 100, the first devices 110 and the fourth device 140 can communicate with each other. In the example of FIG. 1, the first device 110 is illustrated as a terminal device while the fourth device 140 is illustrated as a network device such as a transmission-reception point (TRP). In some example embodiments, if the first device 110 is a terminal device and the fourth device 140 is a network device, a link from the fourth device 140 to the first device 110 is referred to as a downlink (DL), while a link from the first device 110 to the fourth device 140 is referred to as an uplink (UL).

Positioning techniques may be applied to obtain location information of the first devices 110. In some example embodiments, the positioning techniques may be based on DL and DL plus UL positioning measurement taken at a first device 110 for UE-assisted positioning or UL and DL plus UL measurements at the fourth device 140 for network-assisted positioning. In some cases, depending on the category of the communication channel between the first device 110 and the fourth device 140, different positioning techniques may be applied for assurance of positioning accuracy. For example, identifying whether the communication channel has light-of-sight (LOS) propagation or non-line-of-sight (NLOS) propagation, different positioning approaches may be applied. Thus, classifying a category of a communication channel is import at least for its impact on the accuracy of positioning estimation, and improving the classification accuracy may thus improve the overall positioning accuracy.

It has been proposed to deploy one or more classification models at a first device 110 to predict a classification result of a communication channel between the first device 110 and the fourth device 140. A classification model may be built based on AI techniques. The processing by the classification model may be represented as ŷ=f_{AI}(x), where f_{AI} represents the classification model, x represents channel measurement information related to the communication channel, and ŷ represents an estimated classification result predicted by the classification model, to indicate a category into which the communication channel is classified.

The first devices 110 may detect reference signals, such as positioning reference signals (PRS) propagated from the fourth device 140 over respective communication channels, to obtain the channel measurement information. In some example embodiments, the fourth device 140 may transmit PRS according to a channel classification request from the second device 120. In some example embodiments, a communication channel may be classified by a classification model into either a LOS channel (with LOS propagation) or a NLOS channel (with NLOS propagation).

In some example embodiments, the second device 120 may maintain and manage the classification model(s) used by the first devices 110. The second device 120 may include a location server or controller. In some example embodiments, the second device 120 may include a network element in a core network (CN) which is configured for location management. In some example embodiments, the second device 120 may include a location management function (LMF) although other terminologies may be used.

Before deployment of any classification model for channel classification functionality, there is a model training phase which generally requires management on the following three aspects, including in-field channel measurement and labelling, training dataset construction and maintenance, and model online training. The online training may include direct online training and offline-to-online retraining (or updating).

A pre-requirement in model supervised learning is that the training data needs to be labelled beforehand. For a classification model configured for channel classification, the labelled training data may include sample channel measurement information as a sample model input, and a ground-truth classification result as a ground-truth model label. In some example embodiments, external gears/devices may be deployed to support in-field measurement and labelling.

For example, the third device 130 in the communication environment 100 may be configured to facilitate the in-field measurement and classification labelling. The third device 130 is usually capable of determining its location. In some example embodiments, the third device 130 may include a positioning reference unit (PRU) although other terminologies may be used. This third device 130 may be requested by the second device 120 to perform in-field measurement and determine a ground-truth classification result for channel measurement information measured at that location. It is noted that although one third device is illustrated, there may be a plurality of third devices which may be requested to perform classification labelling. In some cases, a classification model may be updated or finetuned to have better performance (e.g., higher accuracy) even this model has been deployed at the devices. Such model updating may require additional labelled training data.

The training efficiency and model performance relies on training data. Informative training data contains more representative features related to the channel and can help more efficiently train the classification model and improve the model performance than those less informative data. However, there is no approach in selecting informative training data for training the classification model. A large scale of available training data may be indiscriminately feed to the classification model for training purpose. The model performance is increased at cost of high computation and time resources. In some cases with high sensitivity to the cost of in-field data collection, reporting and transmission, for example, by requesting a PRU to perform in-field classification labelling, the training data may need to be carefully assessed, selected before being transmitted for model updating. Otherwise, it may lead to resource wasting by requiring the PRU to conduct labelling on areas where the current classification model can already provide descent estimation results or miss the blind spots where more training samples are demanded for model training.

### Work Principle and Example Process

According to some example embodiments of the present disclosure, there is provided a solution for data-efficient updating for channel classification. In this solution, a device determines an importance level of channel measurement information about a communication channel for updating a classification model. The importance level is compared with an importance threshold for the current classification model. If the importance level exceeds the importance threshold, a ground-truth classification result for the communication channel is obtained. The communication measurement information and the ground-truth classification result forms a training data pair for updating the classification model.

Through this solution, high-quality and low-quality data are treated differently according to their importance in updating the classification model. In this way, a small set of high-quality training data which are considered as informative and important can be used to update the classification model. The model performance can be efficiently improved with limited overhead required for classification labelling and model updating.

Example embodiments of the present disclosure will be described in detail below with reference to the accompanying drawings.

Reference is now made to FIG. 2, which shows a flowchart of a process 200 for data-efficient updating of a classification model according to some example embodiments of the present disclosure. The process 200 may be implemented at any suitable device, such as a device in a communication environment 100 of FIG. 1.

At block 210, a device (e.g., the first device 110 or the second device 120) determines an importance level of channel measurement information about a communication channel for updating a classification model.

In some example embodiments, a communication channel to be classified may be a channel for signal propagation between a first device 110 and a fourth device 140. In some example embodiments, the fourth device 140 may transmit a reference signal (e.g., PRS), and a first device 110 may measure the reference signal propagated over the communication channel between the first device 110 and the fourth device 140, to obtain the channel measurement information. In some example embodiments, the first device 110 may include a terminal device, and the fourth device 140 may include a network device.

The channel measurement information (represented as xᵢ) may include one or more types of information that are useful in characterizing the communication channel. In some example embodiments, the channel measurement information xᵢ may include a channel impulse response (CIR), channel status information (CSI), Received Signal Strength Indicator (RSSI), Reference Signal Received Power (RSRP), and/or other information that can be measured. In some example embodiment, the channel measurement information xᵢ may be two-dimensional information, including a spatial domain dimension and a time domain dimension. The spatial domain dimension may be determined by the antenna number at the transmitter of the PRS, and the time domain dimension may be set as larger than a maximum delay spread of wireless signal propagation. The form of the channel measurement information may be configured in other ways, which is not limited in the scope of the present disclosure.

The classification model is configured to determine an estimated classification result of the communication channel based at least in part on the channel measurement information. The channel classification implemented by the classification model may be represented as ŷᵢ=f_{AI}(xᵢ), where f_{AI} represents the classification model, xᵢ represents channel measurement information related to the communication channel, and; represents an estimated classification result.

The classification model may be constructed to extract representative features of the channel measurement information in a high dimensional feature space via machine learning and use the features to classify the communication channel. The classification model may be configured with a plurality of potential channel categories into which a communication channel may be classified. In some example embodiments, the classification model may perform two-category classification, to classify a communication channel into either a first channel category or a second channel category. In some example embodiments, the plurality of channel categories may include a LOS channel and a NLOS channel. The estimated classification result may indicate a predicted probability of the communication channel being classified into a LOS channel or a NLOS channel. Depending on actual applications, other channel categories may also be defined, which is not limited in the scope of the present disclosure.

In some cases, from perspective of lifecycle management of the classification model, it is expected that the classification model can be updated or finetuned to have higher accuracy for communication channels. The training data used for updating the classification model may be collected in field. In example embodiments of the present disclosure, it is proposed to measure importance of the channel measurement information so as to determine whether the channel measurement information is used for updating the classification model. As used herein, “update” or “finetune” the classification model means that a training or retraining process is triggered to update parameter values of the classification model, allowing the classification model to provide more accurate classification results.

On one hand, although the performance of the classification model can be improved if all training data are collected for updating, the training efficiency may be low if the training data cannot contribute new features and information to the classification model.

As an example, in FIG. 1, it is assumed that for a communication channel between the first device 110-1 and the fourth device 140, a classification model generates, based on channel measurement information x₁, an estimated classification result, ŷ₁=f_{AI}(x₁), which indicates that the communication channel is a LOS channel. For a communication channel between the first device 110-2 and the fourth device 140, the classification model generates, based on channel measurement information x₂, an estimated classification result, ŷ₂=f_{AI}(x₂), which indicates that the communication channel is a NLOS channel. For a communication channel between the first device 110-1 and the fourth device 140, the classification model generates, based on channel measurement information x₃, an estimated classification result, ŷ₃=f_{AI}(x₃), which indicates that the communication channel is a LOS channel.

By considering the actual propagation conditions of the communication channels, it can be determined that the estimated classification result at the first device 110-1 is correct and trustworthy, while the estimated classification results at the first devices 110-2 and 110-3 are doubtful. From the perspective of model training efficiency, it is expected that the channel measurement information about the communication channels between the first devices 110-2 and 110-3 and the fourth devices are used to update the classification model, to allow the model to learn and provide correct outputs for other communication channels with similar characteristics.

On the other hand, to form a part of the training data, classification labelling is required for the communication measurement information. The cost of the classification labelling is relatively high. For example, a separate device (e.g., the third device 130) may be requested to perform in-field labelling for the corresponding communication channel, to determine the actual channel category of the communication channel as a ground-truth classification result.

Without importance analysis, it may either cause resource waste to update the classification model with unnecessary training data or inappropriately request for classification labelling for unnecessary data (e.g., x₁) and/or miss the blind spots where classification labelling are needed (e.g., for x₂ and x₃).

In example embodiments of the present disclosure, an importance level of the channel measurement information is assessed, to measure whether the channel measurement information is important in updating the classification model. Channel measurement information important in updating the classification model may involve the case that the channel measurement information is informative and provide new features that are currently not captured by the classification model. In this case, classification labelling of the corresponding communication channel can provide new informative training data to finetune the classification model, for example, to correctly classify communication channels with similar characteristics.

There may be different types of classification models configured for the task of channel classification. For different types of classification models, the importance level of channel measurement information may be determined in different ways. In some example embodiments, intermediate information extracted by the classification model from the channel measurement information may be used directly to determine the importance level of the channel measurement information. In some example embodiments, different intermediate information may be extracted for estimating the importance level for different types of classification models. By fully utilizing the intermediate information, the computational complexity for determining the importance level can be effectively reduced.

To measure whether the channel measurement information is important in updating the classification model, in some example embodiments, the importance level of the channel measurement information may be determined based on uncertainty or trustworthiness of the estimated classification result determined by the classification model based on the channel measurement information. In some example embodiments, an uncertainty level of the estimated classification result may be determined based on the intermediate information extracted by the classification model. The uncertainty level may represent a degree to which the classification model is confident on or doubt about its estimated classification result. The uncertainty level may also be referred to as a doubtfulness level. As an alternative, instead of using the term “uncertainty level,” a certainty level, reliability level, or confidence level of the estimated classification result may be measured.

Generally, it cannot directly identify the root cause of classification error between “ambiguity of the channel itself” and “estimation immaturity of the classification model.” However, the immaturity of the classification model has not been considered, which will likely mislead to improper follow-up actions. For example, if the classification ambiguity is caused by the ambiguity of the channel itself while the classification model is believed to be confident on the estimated classification result, it may impact on choosing follow-up positioning approaches between the geometric typed (e.g., TDOA, AOA, AOD) or fingerprint typed schemes. On the other hand, if the classification ambiguity is caused by the immaturity of the classification model before it is fully trained or finetuned, it may impact on the follow-up training data enhancement and model updating in terms of model lifecycle management, that is, more labelled training data needs to be collected for model finetuning.

In view of the above, it is beneficial to assess the uncertainty or trustworthiness of the estimated classification result given by the current classification model. In some example embodiments, there may be a correspondence relationship between potential uncertainty levels and importance levels. Specifically, if the uncertainty level is a first uncertainty level, the importance level of the channel measurement information may be determined to be a first importance level. If the uncertainty level is a second uncertainty level higher than the first uncertainty level, then the importance level of the channel measurement information may be determined to be a second importance level, the second importance level being higher than the first importance level. That is, a higher uncertainty level of the estimated classification result may correspond to a higher important level of the channel measurement information, to indicate that the communication channel or the channel measurement information may be important for updating the classification model. In some examples, the uncertainty level may be determined as an importance level of the corresponding channel measurement information. In some examples, the importance level of the corresponding channel measurement information may be determined based on one or more other factors other than the uncertainty level.

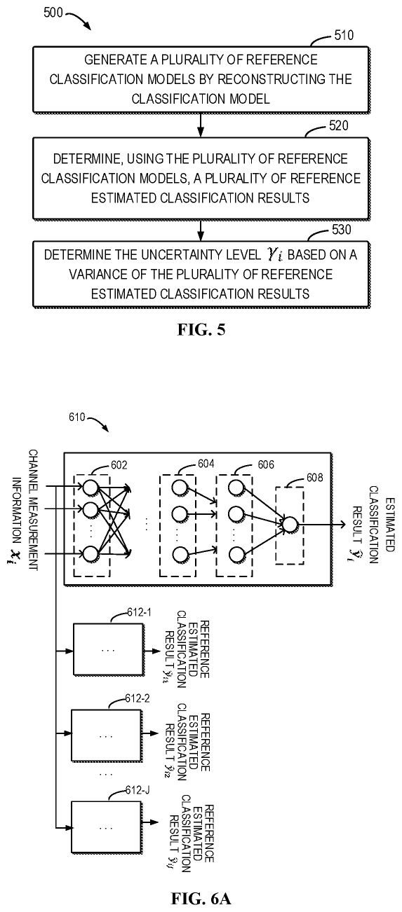

In some example embodiments, the uncertainty level for different types of classification models may be determined in different approaches, by considering the classifying schemes implemented by the classification models and thus leveraging different intermediate information. Some example embodiments of calculating the uncertainty level for different types of classification model will be described in detail below with reference to FIG. 5 to FIG. 10B.

In some example embodiments, in addition to the factor of the uncertainty level of the estimated classification result or as an alternative, the importance level of the channel measurement information may be determined based on other factors that can indicate whether the current communication channel of the first device 110 is informative or important to the improvement of the classification model, for example, based on communication channels in some geographical areas marked as important to the classification model.

With the importance level γᵢ of the channel measurement information xᵢ determined, at block 220, the device (e.g., the first device 110 or the second device 120) determines whether the importance level γᵢ exceeds an importance threshold for the classification model.

The importance threshold may be any predetermined threshold level. The importance threshold may be configured to control how stringent the channel measurement information is evaluated as “important” for updating the classification model.

If the importance level of the channel measurement information exceeds the importance threshold for the classification model, at block 230, the device (e.g., the first device 110 or the second device 120) obtains a ground-truth classification result for the communication channel.

By comparing the importance level with the importance threshold, the device estimates the necessity of requiring a ground-truth classification result for the communication channel to update the classification model. Specifically, if the channel measurement information is determined to be important for updating the classification model (for example, the importance level exceeds the importance threshold), to update the classification model with the channel measurement information, a ground-truth classification result is needed. A ground-truth classification result (represented as yᵢ) is determined as a training target label for the communication channel, and is thus considered as a correct model output for the input channel measurement information xᵢ. In some example embodiments, the ground-truth classification result yᵢ may label the communication channel as either the first channel category (e.g., a LOS channel) or the second channel category (e.g., a NLOS channel).

This ground-truth classification result yᵢ and the channel measurement information xᵢ may form a training data pair {xᵢ,yᵢ} for updating the classification model f_{AI}. With the ground-truth classification result, parameter values of the classification model may be updated to enable the classification model to provide for the input classification measurement information a model output approximating the ground-truth classification result.

In some example embodiments, the ground-truth classification result may be determined by in-field classification labelling. In some example embodiments, a special device, for example, a third device 130 (which may be a PRU) in the environment 100 may be caused to perform classification labelling for the channel measurement information at a location associated with the communication channel of the first device 110. For example, if the channel measurement information is related to a communication channel between the first device 110-1 and the fourth device 140, a third device 130 may perform classification labelling for at least the communication channel at a location associated with the first device 110-1. In some example embodiments, the third device 130 may be requested to perform the classification labelling within an area where the important channel measurement information is found.

In some example embodiments, the location where the third device 130 performing the classification labelling may be any location in an area where the first device 110 is located. In some example embodiments, an appropriate third device 130 which locates in proximity of the first device 110 may be selected to conduct the classification labelling. In some example embodiments, the third device 130 may be movable and can be requested to move to an area where the first device 110 is located. The third device 130 has the capability of determining a ground-truth classification result for a communication channel. It is noted that although one third device 130 is illustrated in the environment 100, there may be multiple third devices which are located in different areas.

In some example embodiments, the third device 130 may be requested by the second device 120 to perform the classification labelling. If the second device 120 needs to obtain the ground-truth classification result, it may select and request an appropriate third device 130 to conduct the classification labelling and receive the ground-truth classification result from the third device 130. If a first device 110 needs to obtain the ground-truth classification result, it may transmit a classification labelling request to the second device 120 which may then select and request an appropriate third device 130 to conduct the classification labelling. In this case, the ground-truth classification result may be forwarded by the second device 120 to the first device 110 or may be transmitted directly from the third device 130 to the first device 110. In some example embodiments, the first device 110 may directly request a third device 130 to assist in determining the ground-truth classification result.

After obtaining the ground-truth classification result, at block 240, the device (e.g., the first device 110 or the second device 120) causes the classification model far to be updated based at least in part on the channel measurement information and the ground-truth classification result.

In some example embodiments, the updating of the classification model may be performed at the first device 110 or the second device 120 locally. In some example embodiments, the first device 110, as a terminal device, may desire to save its computation resources and thus may request the second device 120 or other device to perform the model updating. In this case, the first device 110 may provide the channel measurement information and the ground-truth classification result to the second device 120 or the other device. Any proper model updating or training techniques may be applied for the classification models, which are not limited in the scope of the present disclosure.

In some example embodiments, the channel measurement information and the ground-truth classification result may be added to a training dataset for the classification model. The device (e.g., the first device 110 or the second device 120) may trigger the update of the classification model after enough training data are collected. For example, the device (e.g., the first device 110 or the second device 120) may determine whether the size of training data newly collected exceeds a threshold size. If the size exceeds the threshold size, the update of the classification model may be triggered. In some example embodiments, the second device 120 or a certain first device 110 may collect channel measurement information and corresponding ground-truth classification results from a plurality of first devices 110 to train the classification model. The collected channel measurement information may be determined as having respective importance levels higher than the importance threshold.

Since the training data are assessed as important and informative, the training of the classification model can be accelerated with a small set of training data to be labeled for data-efficient training, and the updated classification model can be improved to have higher accuracy.

In some cases, if the importance level of the channel measurement information is determined to be below the importance threshold, the channel measurement information xᵢ may not be used to update the classification model. In addition, the classification labelling for the channel measurement information xᵢ may be omitted. In this way, the labelling efficiency and model updating efficiency are both improved.

In some example embodiments, the process 200 may be performed in an iterative way. In each round of iteration, the classification model updated from a previous round may be deployed for estimating a classification result for a next round. For example, in a t-th round, a classification model represented as f_{AI(t)} may be deployed and updated to an updated classification model represented as f_{AI(t+1)}. The classification model f_{AI(t+1)} may be further updated in a similar way.

In some example embodiments, the updating of the classification model may be accomplished when a certain criteria is met. The criteria may include a criteria for model training, a criteria that no more channel measurement information is determined to have an importance level higher than the importance threshold (and thus no more on-demand classification labelling is requested), or a combination of the above.

In some example embodiments, the importance threshold may be adaptively updated as the classification model is updated. For example, for the classification model f_{AI(t)}, an importance threshold γₜₕ₍ₜ₎ is used to compare with an importance level(s) of channel measurement information classified by the classification model f_{AI(t)}. If the classification model f_{AI(t)} is updated to f_{AI(t+1)}, the importance threshold γₜₕ₍ₜ₎ is updated to γₜₕ₍ₜ₊₁₎ which is then used to compare with an importance level(s) of channel measurement information classified by the classification model f_{AI(t+1)}.

In some example embodiments, the importance threshold may be increased as an accuracy level of the classification model is increased. After an updated classification model is obtained, its accuracy level may be determined and used to update the importance threshold, to obtain an updated importance threshold for the updated classification model. If the accuracy level of the updated classification model is higher than an accuracy level of the previously used classification model, the importance threshold may be increased by a predetermined value. The incremental value for the importance threshold may be configured as a fixed value, or may be determined based on an increase of the accuracy level. A higher increase in the model accuracy may lead to a higher increase of the importance threshold.

For example, if the classification model has a low accuracy level at initial stage, e.g., 55%, it generally means that the model may hardly distinguish between the channel categories. The importance threshold may be set to a relatively low value, so that more channel measurement information may be assessed as important to allow more training data collected for model updating. As the classification model is updated and become more mature, its accuracy level may increase, and the importance threshold may also be set to a larger value. For example, if the accuracy level of the classification model has climbed to 80%, the classification model may be more confident on its classification result and the importance threshold may also be increased.

The updated importance threshold may be utilized in a next round of model updating, to determine whether channel measurement information estimated by the updated classification model is important for updating this model. By dynamically updating the importance threshold, important and informative training data for the classification model can be filtered out for use in efficient model updating.

In some cases, in addition to the classification model used for estimating the current communication channel, there may be one or more other classification models that are deployed or to be deployed for channel classification. The collected channel measurement information and corresponding ground-truth classification result(s) may be shared among the classification models, to update or train the one or more other classification models. Those classification models may be of different types and/or different model configurations, but may all be configured to classify a communication channel. The channel measurement information considered as important in updating one classification model may also be important and useful in updating other classification models.

In some example embodiments, if the inputs to the different classification models are not the same (for example, different channel measurement information input are required), the third device 130 may be requested to collected different channel measurement information about a same communication channel together with the ground-truth classification result.

It has been discussed above the process implemented for updating of a classification model with importance measure for the training data. As mentioned, this process may be implemented at any suitable device which can obtain the channel measurement information to measure its importance and cause the classification model to be updated with the ground-truth classification result and the channel measurement information. Some examples of such a device is the first device 110 (e.g., a terminal device) which measures the communication channel, the second device 120 (e.g., an LMF) which trains and manages the classification model, or even the fourth device (e.g., a network device). Some example signaling flows related to different implementing devices will be discussed in detail below.

### Example Signaling Flows

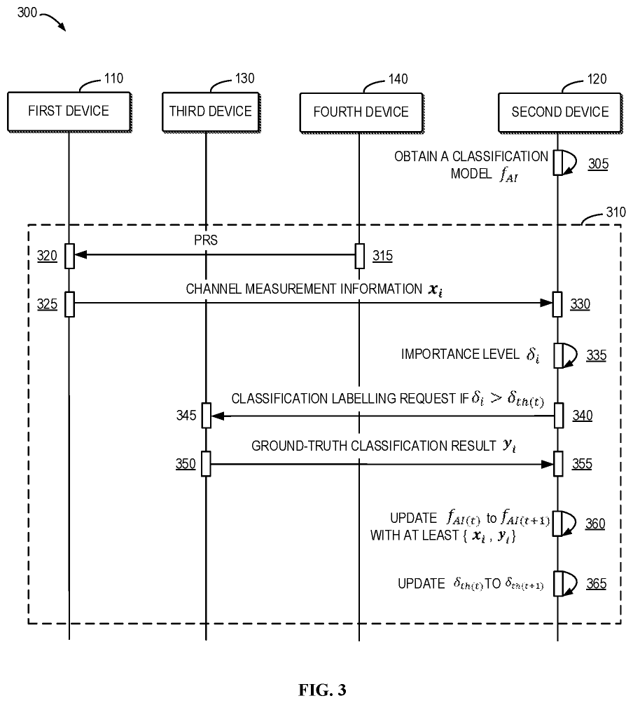

FIG. 3 shows a signaling flow 300 for communication according to some example embodiments of the present disclosure. As shown in FIG. 3, the signaling flow 300 involves a first device 110, a second device 120, a third device 130, and a fourth device 140. For the purpose of discussion, the signaling flow 300 is described with reference to FIG. 1. Although one first device 110, one third device 130, and one fourth device 140 are illustrated in FIG. 3, it would be appreciated that there may be a plurality of first devices performing similar operations as described with respect to the first device 110 below and a plurality of third devices performing similar operations as described with respect to the third device 130 below.

In the example embodiments of FIG. 3, it is assumed that a classification model for communication channel classification is deployed at the second device 120, and the second device 120 is configured for life-cycle management of the classification model. The second device 120 obtains 305 a classification model, represented as f_{AI}.

In some example embodiments, the second device 120 may be configured to initialize parameter values of the classification model and pretrain the classification model with a prestored training dataset that is available. The training dataset may include a plurality of training data pairs, each pair including channel measurement information about a certain communication channel and a classification result labelled for the communication channel. With the training dataset, the classification model may be trained to have the capability of providing preliminary classification for communication channels. The classification model may be premature and may need to be further finetuned to have higher accuracy.

A procedure 310 is implemented to collect training data for updating the classification model. Specifically, the fourth device 140 transmits 315 a PRS to the first device 110. The PRS is prorogated to the first device 110 via a communication channel. The first device 110 measures 320 the PRS to obtain channel measurement information (represented as xᵢ) about the communication channel.

In some example embodiments, the second device 120 may transmit a channel classification request to the fourth device 140 to request for channel classification by transmitting the PRS. In some example embodiments, although not specifically illustrated, the second device 120 may request more than one fourth device 140 to transmit a PRS for channel classification, and a fourth device 140 may transmit a PRS to more than one first device 110.

The first device 110 transmits 325 the channel measurement information xᵢ to the second device 120. Upon receipt 330 of the channel measurement information xᵢ, the second device 120 then determines 335 an importance level δᵢ of the channel measurement information xᵢ for updating the classification model. During the determination of the importance level, the classification model may be used to output an estimated classification result ŷᵢ of the communication channel based on the channel measurement information xᵢ. The classification model used to output the estimated classification result ŷᵢ is represented as f_{AI(t)}. Initially, the classification model trained by the prestored training dataset is represented as f_{AI(0)}. In some example embodiments, the classification model may then be updated iteratively according to the procedure 310.

In some example embodiments, instead of directly transmitting the channel measurement information as illustrated in FIG. 3, the first device 110 may transmit importance assessment information, such as the importance level or the intermediate information for determining the importance level, to the second device 120. In this case, the classification model may be deployed at the first device 110.

In some example embodiments, for some types of classification model which require low overhead for calculating the importance level, the first device 110 may determine the importance level of the channel measurement information and transmit the importance level to the second device 120. In some example embodiments, for some other types of classification model which require high overhead, the first device 110 may request other device, such as the second device 120, to assist in determining the importance level. In this case, the first device 110 may provide the channel measurement information or the intermediate information to the second device 120 to determine the importance level.

With the importance level δᵢ determined, the second device 120 determines whether the importance level δᵢ of the channel measurement information xᵢ exceeds an importance threshold δₜₕ₍ₜ₎ for the classification model f_{AI(t)}. If the importance level di exceeds the importance threshold δₜₕ₍ₜ₎ (e.g., δᵢ>δₜₕ₍ₜ₎, the second device 120 determines to obtain a ground-truth classification result for the communication channel. Specifically, the second device 120 transmits 340 a classification labelling request to an appropriate third device 130 at a location associated with the first device 110. With receipt 345 of the classification labelling request, the third device 130 conducts the classification labelling for the communication channel between the first device 110 and the fourth device 140, to determine a correct channel category of this communication channel. The fourth device 140 transmits 350 a ground-truth classification result yᵢ to the second device 120, which indicates the correct channel category. The ground-truth classification result yᵢ may be used as a target training label of the channel measurement information xᵢ.

After receiving 355 the ground-truth classification result, the second device 120 updates 360 the classification model f_{AI(t)} to a classification model f_{AI(t+1)} with at least the channel measurement information and the ground-truth classification result, {xᵢ,yᵢ}. In some example embodiments, the second device 120 may trigger the updating of the classification model f_{AI(t)} after a plurality of pairs of channel measurement information and corresponding ground-truth classification results are obtained.

In some example embodiments, the second device 120 updates 365 the importance threshold δₜₕ₍ₜ₎ for the classification model f_{AI(t)} to an updated importance threshold δₜₕ₍ₜ₊₁₎ for the updated classification model f_{AI(t+1)}. The updated importance threshold may be determined based on an accuracy level of the updated classification model f_{AI(t+1)}, for example, based on an increase of the accuracy level from the classification model f_{AI(t)} to the updated classification model f_{AI(t+1)}.

In some cases, if the importance level δᵢ of the channel measurement information xᵢ is determined to be below the importance threshold, the second device 120 may discard the channel measurement information xᵢ. In this way, the classification labelling is not triggered for channel measurement information that is not important in updating the model. The labelling efficiency and model updating efficiency are both improved.

In some example embodiments, the procedure 310 may be performed iteratively to finetune the classification model, until the model update is accomplished. The updating of the classification model may be accomplished when a certain criteria is met. The criteria may include a criteria for model training, a criteria that no more channel measurement information is determined to have an importance level higher than the importance threshold (and thus no more on-demand classification labelling is requested), or a combination of the above.

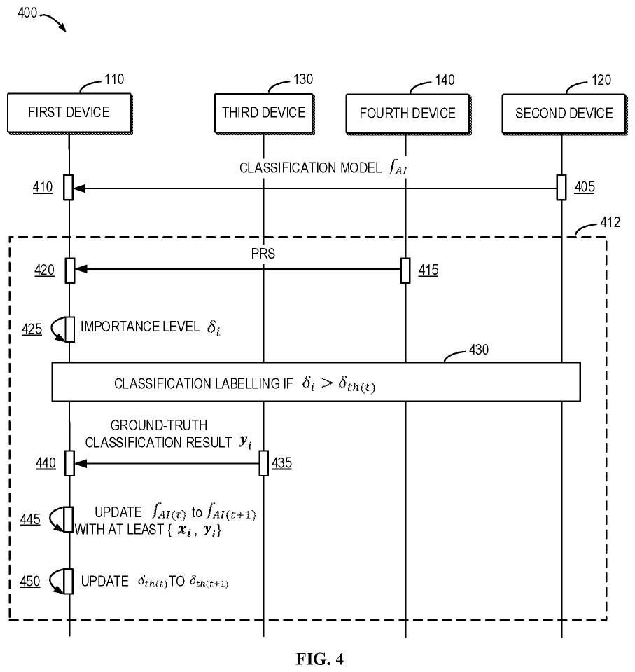

In some example embodiments, it is assumed that a classification model for communication channel classification is deployed at the first device 110, and the first device 110 is configured for life-cycle management of the classification model. FIG. 4 shows a signaling flow 400 according to such example embodiments.

As shown in FIG. 4, the signaling flow 400 involves a first device 110, a second device 120, a third device 130, and a fourth device 140. For the purpose of discussion, the signaling flow 400 is described with reference to FIG. 1. Although one first device 110, one third device 130, and one fourth device 140 are illustrated in FIG. 4, it would be appreciated that there may be a plurality of first devices performing similar operations as described with respect to the first device 110 below and a plurality of third devices performing similar operations as described with respect to the third device 130 below.

In the example embodiments of FIG. 4, the second device 120 provides 405 a classification model, represented as f_{AI} to the first device 110. The first device 110 downloads 410 the classification model from the second device 120.

In some example embodiments, the second device 120 may provide the classification model upon receipt of a positioning service request from the first device 110. This classification model may have been trained by the second device 120 with a prestored training dataset or a training dataset that is partially or all collected from in-field data, for example, through the signaling flow 300.

A procedure 412 is implemented to collect training data for updating the classification model deployed at the first device 110. Specifically, the fourth device 140 transmits 415 a PRS to the first device 110. The PRS is prorogated to the first device 110 via a communication channel. In some example embodiments, the second device 120 may transmit a channel classification request to the fourth device 140 to request for channel classification by transmitting the PRS.

The first device 110 measures 420 the PRS to obtain channel measurement information (represented as xᵢ) about the communication channel. The first device 110 may use the classification model to determine an estimated classification result ŷᵢ of the communication channel based on the channel measurement information xᵢ. The classification model used to output the estimated classification result ŷᵢ is represented as f_{AI(t)}. Initially, the classification model trained by the prestored training dataset is represented as f_{AI(0)}. In some example embodiments, the classification model may then be updated iteratively according to the procedure 412.

The first device 110 determines 425 an importance level δᵢ of the channel measurement information xᵢ for updating the classification model. In some example embodiments, considering the workload of determining the importance level for certain types of classification model as mentioned above, the first device 110 may request other devices, such as the second device 120 to determine the importance level by providing the channel measurement information and/or other necessary information to the other devices.

The first device 110 compares the importance level δᵢ with an importance threshold δₜₕ₍ₜ₎ for the classification model f_{AI(t)}. If the importance level δᵢ exceeds the importance threshold δₜₕ₍ₜ₎ (e.g., δᵢ>δₜₕ₍ₜ₎, the first device 110 determines to obtain a ground-truth classification result for the communication channel. In this case, the first device 110 triggers 430 a sub-process for classification labelling on the communication channel.

In some example embodiments, in the sub-process for classification labelling, the first device 110 may transmit a classification labelling request to the second device 120. The second device 120 may then select and request an appropriate third device 130 to perform the classification labelling at a location associated with the first device 110. In some example embodiments, in the sub-process for classification labelling, the first device 110 may directly request the third device 130 to perform the classification labelling.

The first device 110 receives 440 a ground-truth classification result yᵢ transmitted 435 from the third device 130, which indicates a channel category of the communication channel between the first device 110 and the fourth device 140. The ground-truth classification result yᵢ may be used as a target training label of the channel measurement information xᵢ. In some example embodiments, the third device 130 may report the ground-truth classification result yᵢ to the second device 120. The first device 110 may receive the ground-truth classification result yᵢ forwarded by the second device 120.

The first device 110 updates 445 the classification model f_{AI(t)} to a classification model f_{AI(t+1)} with at least the channel measurement information and the ground-truth classification result, {xᵢ,yᵢ}. In some example embodiments, the first device 110 may trigger the updating of the classification model f_{AI(t)} after a plurality of pairs of channel measurement information and corresponding ground-truth classification results are obtained.

In some example embodiments, the first device 110 updates 450 the importance threshold δₜₕ₍ₜ₎ for the classification model f_{AI(t)} to an updated importance threshold δₜₕ₍ₜ₊₁₎ for the updated classification model f_{AI(t+1)}. The updated importance threshold may be determined based on an accuracy level of the updated classification model f_{AI(t+1)}, for example, based on an increase of the accuracy level from the classification model f_{AI(t)} to the updated classification model f_{AI(t+1)}.

In some example embodiments, instead of updating the classification model and/or the importance threshold locally, the first device 110 may cause the updating to be performed by other devices, such as the second device 120. The first device 110 may provide the channel measurement information and/or the ground-truth classification result to facilitate the updating of the classification model and then the updating of the importance threshold. The scope of the present disclosure is not limited in this regard.

In some cases, if the importance level δᵢ of the channel measurement information xᵢ is determined to be below the importance threshold, the first device 110 may discard the channel measurement information xᵢ. In this way, the classification labelling is not triggered for channel measurement information that is not important in updating the model. The labelling efficiency and model updating efficiency are both improved.

In some example embodiments, the procedure 412 may be performed iteratively to finetune the classification model, until the model update is accomplished. The updating of the classification model may be accomplished when a certain criteria is met. The criteria may include a criteria for model training, a criteria that no more channel measurement information is determined to have an importance level higher than the importance threshold (and thus no more on-demand classification labelling is requested), or a combination of the above.

It has been described above from the perspective of the second device 120 or the first device 110 about the updating of the classification model for channel classification. In some example embodiments, the fourth device 140 may obtain the channel measurement information, e.g., by receiving it from the first device 110 or by measuring a reference signal transmitted from the first device 110. In such cases, if the classification model is deployed at the fourth device 140, the fourth device 140 may perform similar operations as described herein with respect to the first device 110, to update the classification model.

### Example of Classification Model and Uncertainty Level Calculation

As mentioned above, an uncertainty level of an estimated classification result (and thus the importance level of the channel measurement information) may be determined depending on a type of the classification model.

In some example embodiments, for a certain type of classification model, the uncertainty level of the estimated classification result may be determined by reconstructing the classification model. An example of such classification model is a deep neural network (DNN), which generally provides a hard output (e.g., 0 or 1) to indicate whether the communication channel is classified into the first channel category or the second channel category. For such a type of classification model, a plurality of reference classification models may be generated by reconstructing the classification model and used to determine the uncertainty level.

FIG. 5 illustrates a flowchart of a process 500 for determining an uncertainty level of an estimated classification result output by a DNN typed classification model according to some example embodiments of the present disclosure. The process 500 may be implemented, for example, by a device which needs to determine the uncertainty level (or the importance level). Such a device may include the first device 110 or the second device 120.

At block 510, the device (e.g., the first device 110 or the second device 120) generates a plurality of reference classification models by reconstructing the classification model.

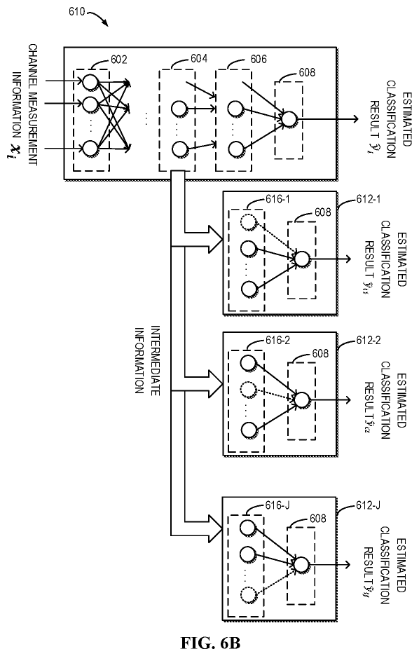

FIG. 6A illustrates an example of a DNN typed classification model 610 and reference classification models generated therefrom according to some example embodiments of the present disclosure. The classification model 610 may be in form of DNN model.

As shown in FIG. 6A, the classification model 610 is configured of an input layer 602, one or more intermediate layers 604, 606, and an output layer 608, each of the layers comprising a plurality of operation units (sometimes referred to as neurons). Operation units in one layer are connected to operation units in a following layer. In some example embodiments, an operation unit in one layer may be connected with one or more other operation units in the same layer. Channel measurement information xᵢ is input to the input layer 602 for processing, and the information is propagated through the inside of the intermediate layer(s) 604, 606 according to the connections of the layers. An estimated classification result ŷᵢ for the channel measurement information xᵢ is outputted from the output layer 608. Examples of the layers included in the classification model may include a convolution layer, the batch normalization, activation function, pooling layer, fully connected layer, LSTM (Long Short Term Memory) layer, and other types of layers.

It is noted that the number of operation units and the number of layers in the classification model 610 have no relation with the example embodiments of the present disclosure, and these numbers are given values. The structure of the classification model is also non-limiting, and may have recurrence or the bidirectional property to the connection between the operation units. Any model applicable for channel classification may be used.

For DNN typed models and similar models, there is no general solution available yet to directly measure the uncertainty level of the estimated result based on the model output and input. It is noteworthy that even if a DNN typed classification model outputs a probability vector as the estimated classification result, it may not be directly used to indicate the uncertainty level of the estimated classification result. That is, a classification model can be uncertain in its predictions even with a high output probability. In some example embodiments, it is proposed to reconstruct the classification model by slightly changing the model to generate a plurality of reference classification models, and determine the uncertainty level based on the plurality of reference classification models.

In the example of FIG. 6A, J reference classification models 612-1, 612-2, . . . , 612-J (collectively or individually referred to as reference classification models 612) for the classification model, where J is an integer larger than one. In some example embodiments, the classification model may be reconstructed by applying random neural connection dropout. Specifically, some neural connections between the operation units in different layers of the classification model may be dropped out, to obtain a reference classification model. In some example embodiments, a dropout ratio may be applied to determine the ratio of dropped out neural connections. In some example embodiments, the second device 120 may apply a Gaussian process to determine which neural connections are dropped out from the classification model. In some other example embodiments, other dropout means may also be applied to generate the reference classification models.

In some example embodiments, a reference classification model may be constructed to have the channel measurement information xᵢ as its model input and output a reference estimated classification result. In such example embodiments, a reference classification model may have a similar structure as the classification model except that some neural connections are dropped out. A reference estimated classification result output by a j-th reference classification model may be represented as ŷᵢⱼ, where j=1, 2, . . . , J.

In some example embodiments, considering that the DNN typed classification model has a layered structure and thus may consist of different consecutive model parts, where an output of a first model part may be provided for further processed in a next second model part. The intermediate information propagated among different model parts (or layers) may be referred to as feature information or latent information of the input channel measurement information. In some example embodiments, the DNN typed classification model may be considered as including a feature extraction model part and a detection model part. The feature extraction model part may be implemented by human designed feature engineering or by machine itself via deep learning, to extract feature information from the channel measurement information. The detection model part may be implemented as having one or more fully connected neurons and an output layer (such as the output layer 508 in FIG. 5A). The detection model part may receive the feature information extracted by the feature extraction model part and process the feature information to output the estimated classification result.

In some example embodiments, to reduce the computational complexity, the plurality of reference classification model may be generated by reconstructing a rear model part of the classification model. For example, if the classification model is divided into a first model part (e.g., the feature extraction model part) followed by a second model part (e.g., the detection model part), the plurality of reference classification models may be generated by reconstructing the second model part. In some example embodiments, the second model part to be reconstructed may include one or more last layers of the classification model. In this way, the intermediate information output by the first model part (e.g., the feature information extracted by the feature extraction model part) of the classification model may be reused by the plurality of reference classification models.

FIG. 6B illustrates an example of reference classification models generated from the second model part of the classification model. As illustrated, a second model part including the layers 606 and 608 of the classification model 610 may be reconstructed to generate the J reference classification models 612, for example, by dropping out one or more neural connections between the layers 606 and 608. For example, neurons in the layer 606 may be dropped out in different ways to generate different layers 616-1, 616-2, . . . 616-J for the J reference classification models 612, respectively.

Referring back to FIG. 5, at block 520, the device (e.g., the first device 110 or the second device 120) determines, using the plurality of reference classification models, a plurality of reference estimated classification results ŷᵢⱼ (j=1, 2, . . . , J).

In some example embodiments related to FIG. 6A, the channel measurement information xᵢ may be directly provided as input to the plurality of reference classification models 612. The plurality of reference classification models 612 may process the channel measurement information xᵢ independently to generate respective reference estimated classification results ŷᵢⱼ. In some example embodiments related to FIG. 6B, intermediate information extracted by the first model part of the classification model 610 may be provided as input to the plurality of reference classification models 612. In this way, the computation complexity and resource cost may be reduced as the intermediate information can be reused. The reference classification models 612 may further process the intermediate information to generate respective reference estimated classification results ŷᵢⱼ (j=1, 2, . . . , J).

At block 530, the device (e.g., the first device 110 or the second device 120) determines an uncertainty level (represented as γᵢ) of the estimated classification result ŷᵢ for the channel measurement information xᵢ based on a variance of the plurality of reference estimated classification results ŷᵢⱼ (j=1, 2, . . . , J).

In some example embodiments, if the variance of the plurality of reference estimated classification results ŷᵢⱼ (j=1, 2, . . . , J) is relatively high, which means that the reference classification models are not consistent in classifying the channel measurement information xᵢ, and thus the original classification model may not be confident about the estimated classification result ŷᵢ. In this case, the uncertainty level γᵢ of the estimated classification result ŷᵢ may be determined as a relatively high level and thus the channel measurement information may be determined as informative and important for updating the original classification model. In this way, xᵢ is considered as being of high importance and the classification model needs to be updated to become stable and have more confidence in classifying similar communication channels even if the model structure is slightly changed (e.g., by dropping out some connections).

In some example embodiments, if the variance of the plurality of reference estimated classification results is relatively low, the uncertainty level γᵢ of the estimated classification result ŷᵢ may be determined as a relatively low level and thus the channel measurement information may be determined as not important for updating the original classification model.

The variance of the plurality of reference estimated classification results may be measured in any appropriate ways. In some example embodiments, the variance of the plurality of reference estimated classification results may be determined based on each of the individual reference estimated classification results and the expectation of the reference estimated classification results. In some example embodiments, an estimated classification results ŷᵢⱼ may be represented as a vector, including elements to indicate respective probabilities of a communication channel being classified into the first and second channel categories. In this way, the uncertainty level γᵢ may be determined as follows:

$${γ}_{i} = {τ}^{- 1} I + \frac{1}{J} {\sum }_{j = 1}^{J} {\hat{y}}_{i j}^{T} {\hat{y}}_{ij} - {𝔼 [ {y}_{i} ]}^{T} [ {y}_{i} ] \qquad ( 1 )$$

where I is the identity matrix and

$$𝔼 [ {y}_{i} ] = \frac{1}{J} {\sum }_{j = 1}^{J} {\hat{y}}_{ij}$$

$$τ = \frac{( 1 - d ) {l}^{2}}{2 N λ}$$

where [symbol] represents the expectation, N is the number of input channel measurement information samples input to the classification model, d is a dropout ratio, λ is the weight decay of a L2 regulation term in the classification model, l is the prior length-scale describing the prior knowledge of parameter values of the classification model.

It is noted that the above Equation (1) is just a specific example for calculating the uncertainty level γᵢ based on the variance. There may be many other approaches to calculate the variance and then the uncertainty level, which is not limited in the scope of the present disclosure.

As mentioned above, with the uncertainty level of the estimated classification result determined, the importance level of the corresponding channel measurement information may be determined accordingly. As discussed above, the importance level may be used to select important channel measurement information for updating the classification model, to allow the model trained efficiently.

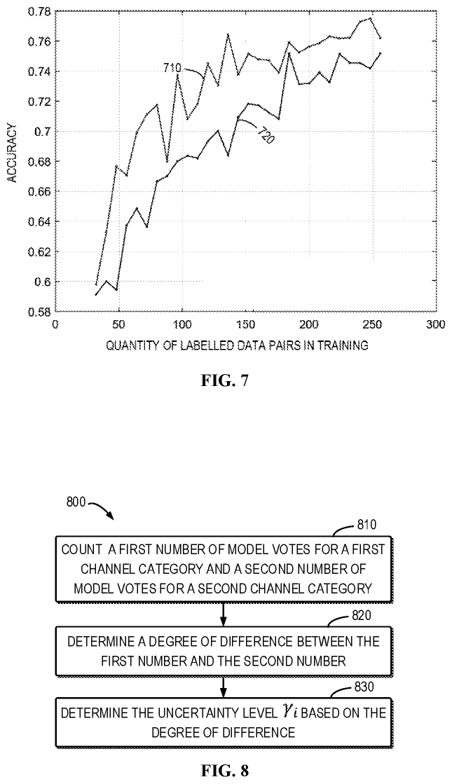

FIG. 7 illustrates model performance gain by some example embodiments of the present disclosure relative to a traditional model training approach. According to the traditional model training approach, classification labelling for channel measurement information may be performed randomly without importance assessment and thus training data (channel measurement information and ground-truth classification results) are randomly utilized to update a DNN typed classification model. According to the example embodiments of the present disclosure, important and informative channel measurement information is found to update the DNN typed classification model.

FIG. 7 shows an accuracy trend curve 710 for the proposed approach according to some example embodiments of the present disclosure and an accuracy trend curve 720 for the traditional model training approach. The two trend curves both show the accuracy climbing versus the quantity of labelled training data for training a DNN typed classification model. As can be seen, to reach a same accuracy level, the quantity of labelled training data pairs required in the example embodiments of the present disclosure can be roughly reduced as compared with the traditional approach.

### Further Example of Classification Model and Uncertainty Level Calculation

In some example embodiments, for certain types of classification model, the uncertainty level γᵢ of the estimated classification result ŷᵢ may be assessed without reconstructing the classification model. In some example embodiments, some types of classification model may provide soft outputs which are used to further derive the estimated classification result ŷᵢ. As an example, in the case of binary classification, a classification model may determine, based on the channel measurement information xᵢ, a first number (represented as “N1”) of model votes for a first channel category and a second number (represented as “N2”) of model votes for a second channel category. The estimated classification result may be determined based on a ratio of the first number to the second number (e.g., N1/N2), where a higher ratio may indicate a higher probability that the communication channel is classified into the first channel category.

Some examples for this type of classification model may include, but are not limited to, a k-nearest neighbor (KNN) model, a support vector machine (SVM) model, and a random forest (RF) model. In some example embodiments, the uncertainty level of the estimated classification result output by such a type of classification model may be determined based on the intermediate information, e.g., the first number of model votes for the first channel category, N1 and the second number of model votes for the second channel category, N2.

FIG. 8 illustrates a flowchart of a process 800 for determining an uncertainty level of an estimated classification result output by a DNN typed classification model according to some example embodiments of the present disclosure. The process 800 may be implemented, for example, by a device which needs to determine the uncertainty level (or the importance level). Such a device may include the first device 110 or the second device 120.

At block 810, the device (e.g., the first device 110 or the second device 120) counts the first number of model votes for the first channel category, N1 and the second number of model votes for the second channel category, N2. The two numbers may be obtained from the classification model, without reconstructing the classification model.

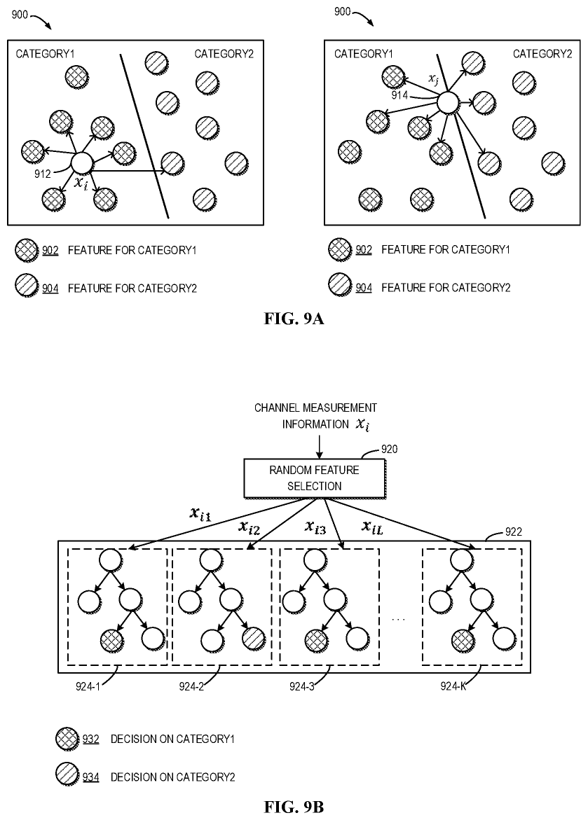

FIG. 9A illustrate examples of a KNN typed classification model according to some example embodiments of the present disclosure. In FIG. 9A, a feature space 900 includes a plurality of features 902 associated with the first channel category (represented as “Category1”) and a plurality of features 904 associated with the second channel category (represented as “Category2”). According to the KNN typed classification model, the classifying scheme is configured to measure respective distances between a feature extracted from the channel measurement information and the features in the feature space 900 and select a predetermined number (for example, K) of features with low distances (for example, K features with the lowest distances).

Among a total of K selected features, the classification model may count a first number of features associated with the first channel category (i.e., the first number of model votes for the first channel category, N1) and a second number of features associated with the second channel category (i.e., the second number of model votes for the second channel category, N2). The first number and the second number may be used to determine the probability of the communication channel belonging to the first channel category.

In the example of FIG. 9A, a feature 912 of channel measurement information xᵢ obtained by the first device 110-1 is close to six features associated with Category 1 and one feature associated with Category2. Thus, a first probability of the communication channel being the first channel category is 1/7, and a second probability of the communication channel being the second channel category is 6/7. Since the second probability is higher than the first probability, the estimated classification result may be determined to indicate that the communication channel is classified into the second channel category. Since 6/7 is close to 100%, it indicates the estimation uncertainty level of this result is low, xᵢ and therefore is not important for updating the classification model.

In another example, a feature 914 of channel measurement information xⱼ is close to four features associated with Category1 and three features associated with Category2. Thus, a first probability of the communication channel being the first channel category is 4/7, and a second probability of the communication channel being the second channel category is 3/7. Since the first probability (i.e., 4/7) is higher than the second probability, the estimated classification result may be determined to indicate that the communication channel is classified into the first channel category. However, since 4/7 is close to 50%, it indicates the estimation uncertainty level of this result is high, xᵢ and therefore is important for updating the classification model.

It would be appreciated that the examples of FIG. 9A is provided for the purpose of illustration, without suggesting the classifying approaches of the KNN typed classification model of the first type. Some classification models may operate in other ways to determine the model votes for the two channel categories and then output the estimated classification result.

FIG. 9B illustrate examples of a RF typed classification model according to some example embodiments of the present disclosure. In FIG. 9B, a RF typed classification model 922 comprises a plurality of decision trees 924-1, 924-2, 924-3, . . . , 924-K (collectively or individually represented as decision trees 924). A random feature selection part 920 is configured to randomly extract, from the channel measurement information xᵢ, K subsets of information or features, represented as xᵢ₁, xᵢ₂, xᵢ₃, . . . , x_{iK}.

The L subsets of information or features xᵢ₁, xᵢ₂, xᵢ₃, . . . , x_{iK} may be provided as input to the decision trees 924-1, 924-2, 924-3, . . . , 924-K, respectively. A decision tree 924 may be configured to process a subset of information or features and output a decision about channel classification. Specifically, a decision tree 924 may be configured with two potential outputs, one output indicating the first channel category (represented as “Category1”) and the other output indicating the second channel category (represented as “Category2”). In the illustrated example of FIG. 9B, the decision trees 924-1, 924-3, 924-K and probably other decision trees may output a decision 932 on Category1, and the decision tree 924-2 and probably other decision trees may output a decision 934 on Category2.

In the RF typed classification model 922, the number of decisions on Category1 is represented as N1 and the number of decisions on Category1 is represented as N2, where N1+N2=K. The estimated classification result for the communication channel may be determined by comparing N1 with N2. In some examples, according to an example policy configured in the RF typed classification model 922, if N1 is larger than N2, the estimated classification result may be determined to indicate that the communication channel is classified into the first channel category. Otherwise, if N1 is lower than or equal to than N2, the estimated classification result may be determined to indicate that the communication channel is classified into the second channel category.

It would be appreciated that the SVM typed classification model may operate in a similar way as the KNN typed classification model which will not be specifically illustrated. The first number for the first channel category and the second number for the first channel category may be obtainable from the classification model and thus can be used to help determine the uncertainty level of the estimated classification result.

At block 820, the device (e.g., the first device 110 or the second device 120) determines a degree of difference between the first number N1 for the first channel category and the second number N2 for the second channel category. At block 830, the device (e.g., the first device 110 or the second device 120) determines the uncertainty level γᵢ of the estimated classification result ŷᵢ based on the degree of difference.

In the case of model votes for binary classification, if the classification model is more confident about its estimation, the number of model votes for one channel category may be larger and correspondingly, the number of model votes for the other channel category may be smaller. Therefore, if the degree of difference between the first number and the second number is relatively high, it means that the classification model is relatively confident on its classification result and thus the uncertainty level of the estimated classification result may be low.

In some example embodiments, a sum of N1 and N2 is determined as K, and the degree of difference between the first number N1 and the second number N2 may be measured based on a larger value between a ratio of N1 to K, and a ratio of N2 to K, which may be represented as min (N1, N2)/K. In some example embodiments, the degree of difference between the first number N1 and the second number N2 may be measured based on a lager value between N1/N2, or N2/N1, which may be represented as min (N1/N2, N2/N1). In these cases, the uncertainty level γᵢ may be determined to be a higher level if min (N1, N2)/K or min (N1/N2, N2/N1) is determined to have a higher value. In some examples, the uncertainty level γᵢ may be determined as follows: γᵢ=min (N1, N2)/K or min (N1/N2, N2/N1). In other examples, the uncertainty level γᵢ may be determined in other ways based on the degree of difference between N1 and N2.

There may be many other approaches to calculate the uncertainty level based on the first number for the first channel category and the second number for the second channel category, which is not limited in the scope of the present disclosure.

As mentioned above, with the uncertainty level of the estimated classification result determined, the importance level of the corresponding channel measurement information may be determined accordingly. As discussed above, the importance level may be used to select important channel measurement information for updating the classification model, to allow the model trained efficiently.

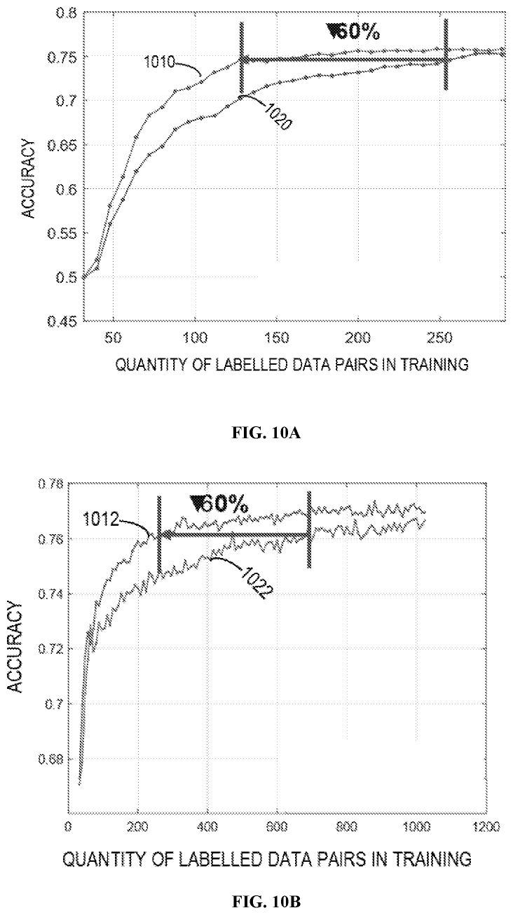

FIG. 10A illustrates model performance gain by some example embodiments of the present disclosure for a KNN typed classification model relative to a traditional model training approach. FIG. 10B illustrates model performance gain by some example embodiments of the present disclosure for a RF typed classification model relative to a traditional model training approach. According to the traditional model training approach, classification labelling for channel measurement information may be performed randomly without importance assessment and thus training data (channel measurement information and ground-truth classification results) are randomly utilized to update a KNN typed classification model or a RF typed classification model. According to the example embodiments of the present disclosure, important and informative channel measurement information is found to update the DNN typed classification model or the RF typed classification model.

FIG. 10A shows an accuracy trend curve 1010 for the proposed approach according to some example embodiments of the present disclosure and an accuracy trend curve 1020 for a traditional model training approach. The two trend curves both show the accuracy climbing versus the quantity of labelled training data for training a KNN typed classification model. As can be seen, to achieve the same model performance in terms of classification accuracy, the quantity of labelled training data required for the classification model can be roughly reduced by 60% using the proposed approach according to some example embodiments of the present disclosure, comparing to the traditional approach.

FIG. 10B also shows an accuracy trend curve 1012 for the proposed approach according to some example embodiments of the present disclosure and an accuracy trend curve 1022 for a traditional model training approach. The two trend curves both show the accuracy climbing versus the quantity of labelled training data for training a RF typed classification model. As can be seen, to achieve the same model performance in terms of classification accuracy, the quantity of labelled training data required for the classification model can be roughly reduced by 60% using the proposed approach according to some example embodiments of the present disclosure, comparing to the traditional approach.

### Example Apparatus, Device and Medium

In some example embodiments, an apparatus capable of performing any of the method 800 (for example, the first device 110 or the second device 120 in FIG. 1) may comprise means for performing the respective operations of the method 800. The means may be implemented in any suitable form. For example, the means may be implemented in a circuitry or software module. The apparatus may be implemented as or included in the first device 110 or the second device 120 in FIG. 1.

In some example embodiments, the apparatus comprises: means for determining an importance level of channel measurement information about a communication channel for updating a classification model, the classification model configured to determine an estimated classification result of the communication channel based on the channel measurement information; means for in accordance with a determination that the importance level of the channel measurement information exceeds an importance threshold for the classification model, obtaining a ground-truth classification result for the communication channel; and means for causing the classification model to be updated based at least in part on the channel measurement information and the ground-truth classification result.

In some example embodiments, the apparatus further comprises: means for determining an accuracy level of the updated classification model; and means for updating the importance threshold based on the accuracy level, to obtain an updated importance threshold for the updated classification model.

In some example embodiments, the means for updating the importance threshold based on the accuracy level comprises: means for, in accordance with a determination that the accuracy level of the updated classification model is higher than an accuracy level of the classification model, increasing the importance threshold by a predetermined value.

In some example embodiments, the means for determining the importance level comprises: means for obtaining intermediate information extracted by the classification model from the channel measurement information; and means for determining the importance level of the channel measurement information based on the intermediate information.

In some example embodiments, the means for determining the importance level based on the intermediate information comprises: means for determining an uncertainty level of the estimated classification result based on the intermediate information; means for, in accordance with a determination that the uncertainty level is a first uncertainty level, determining the importance level of the channel measurement information to be a first importance level; and means for, in accordance with a determination that the uncertainty level is a second uncertainty level higher than the first uncertainty level, determining the importance level of the channel measurement information to be a second importance level, the second importance level being higher than the first importance level.

In some example embodiments, the means for determining the uncertainty level of the estimated classification result comprises: means for, in accordance with a determination that the classification model is a deep neural network, generating a plurality of reference classification models by applying random neural connection dropout on the classification model; means for determining, using the plurality of reference classification models, a plurality of reference estimated classification results based on the intermediate information; and means for determining the uncertainty level based on a variance of the plurality of reference classification results.

In some example embodiments, the classification model comprises a first model part and a second model part connected to the first model part, and the means for generating the plurality of reference classification models comprises: means for generating the plurality of reference classification models by applying random neural connection dropout on the second model part of the classification model.

In some example embodiments, the intermediate information comprises feature information extracted by the first model part of the classification model from the channel measurement information. The means for determining the plurality of reference estimated classification results comprises: means for applying the feature information as input to the plurality of reference classification models, and means for obtaining the plurality of reference estimated classification results output from the plurality of reference classification models.

In some example embodiments, the intermediate information comprises a first number of model votes for a first channel category and a second number of model votes for a second channel category by the classification model based on the channel measurement information, and the estimated classification result is determined based on the first number and the second number. The means for determining the uncertainty level of the estimated classification result comprises: means for determining a degree of difference between the first number for the first channel category and the second number for the second channel category, and means for determining the uncertainty level based on the degree of difference.

In some example embodiments, the means for obtaining the ground-truth classification result comprises: means for causing a positioning reference device to perform classification labelling for the channel measurement information at a location associated with the communication channel; and means for receiving the ground-truth classification result from the positioning reference device.

In some example embodiments, the estimated classification result indicates whether the communication channel is classified as a line-of-sight channel or a non-line-of-sight channel.

In some example embodiments, the apparatus comprises a terminal device or a location management function.

In some example embodiments, the apparatus further comprises means for performing other operations in some example embodiments of the process 200 or the first or second device 110 or 120. In some example embodiments, the means comprises at least one processor; and at least one memory storing instructions that, when executed by the at least one processor, cause the performance of the apparatus.

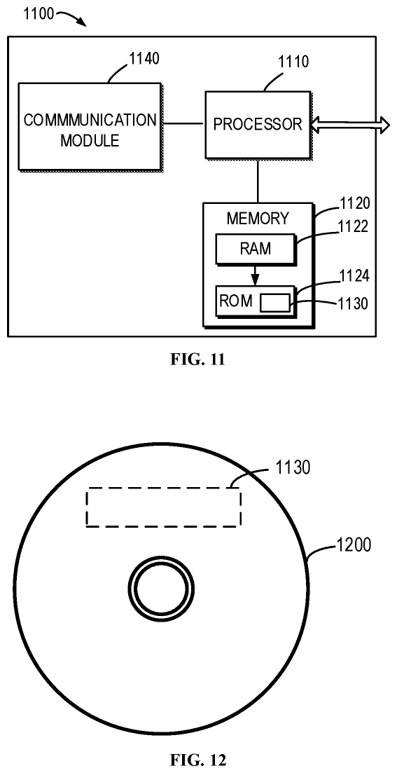

FIG. 11 is a simplified block diagram of a device 1100 that is suitable for implementing example embodiments of the present disclosure. The device 1100 may be provided to implement a communication device, for example, the first device 110, the second device 120, or other devices as shown in FIG. 1. As shown, the device 1100 includes one or more processors 1110, one or more memories 1120 coupled to the processor 1110, and one or more communication modules 1140 coupled to the processor 1110.

The communication module 1140 is for bidirectional communications. The communication module 1140 has one or more communication interfaces to facilitate communication with one or more other modules or devices. The communication interfaces may represent any interface that is necessary for communication with other network elements. In some example embodiments, the communication module 1140 may include at least one antenna.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the memory, e.g., ROM 1124. The processor 1110 may perform any suitable actions and processing by loading the program 1130 into the RAM 1122.

The example embodiments of the present disclosure may be implemented by means of the program 1130 so that the device 1100 may perform any process of the disclosure as discussed with reference to FIGS. 2 to 10B. The example embodiments of the present disclosure may also be implemented by hardware or by a combination of software and hardware.

In some example embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like. FIG. 12 shows an example of the computer readable medium 1200 which may be in form of CD, DVD or other optical storage disk. The computer readable medium 1200 has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The term “non-transitory,” as used herein, is a limitation of the medium itself (i.e., tangible, not a signal) as opposed to a limitation on data storage persistency (e.g., RAM vs. ROM). The computer program product includes computer-executable instructions, such as those included in program modules, being executed in a device on a target physical or virtual processor, to carry out any of the methods as described above with reference to FIGS. 2 to 10B. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A device comprising:
at least one processor; and
at least one memory storing instructions that, when executed by the at least one processor, cause the device at least to perform:
determining an importance level of channel measurement information about a communication channel for updating a classification model, the classification model configured to determine an estimated classification result of the communication channel based on the channel measurement information;
in accordance with a determination that the importance level of the channel measurement information exceeds an importance threshold for the classification model, obtaining a ground-truth classification result for the communication channel; and
causing the classification model to be updated based at least in part on the channel measurement information and the ground-truth classification result.

2. The device of claim 1, wherein the device is further caused to perform:
determining an accuracy level of the updated classification model; and
updating the importance threshold based on the accuracy level, to obtain an updated importance threshold for the updated classification model.

3. The device of claim 2, wherein updating the importance threshold based on the accuracy level comprises:
in accordance with a determination that the accuracy level of the updated classification model is higher than an accuracy level of the classification model, increasing the importance threshold by a predetermined value.

4. The device of claim 1, wherein determining the importance level comprises:
obtaining intermediate information extracted by the classification model from the channel measurement information; and
determining the importance level of the channel measurement information based on the intermediate information.

5. The device of claim 4, wherein determining the importance level based on the intermediate information comprises:
determining an uncertainty level of the estimated classification result based on the intermediate information;
in accordance with a determination that the uncertainty level is a first uncertainty level, determining the importance level of the channel measurement information to be a first importance level; and
in accordance with a determination that the uncertainty level is a second uncertainty level higher than the first uncertainty level, determining the importance level of the channel measurement information to be a second importance level, the second importance level being higher than the first importance level.

6. The device of claim 5, wherein determining the uncertainty level of the estimated classification result comprises:
in accordance with a determination that the classification model is a deep neural network, generating a plurality of reference classification models by applying random neural connection dropout on the classification model;
determining, using the plurality of reference classification models, a plurality of reference estimated classification results based on the intermediate information; and
determining the uncertainty level based on a variance of the plurality of reference classification results.

7. The device of claim 6, wherein the classification model comprises a first model part and a second model part connected to the first model part, and wherein generating the plurality of reference classification models comprises:
generating the plurality of reference classification models by applying random neural connection dropout on the second model part of the classification model.

8. The device of claim 7, wherein the intermediate information comprises feature information extracted by the first model part of the classification model from the channel measurement information; and
wherein determining the plurality of reference estimated classification results comprises:
applying the feature information as input to the plurality of reference classification models, and
obtaining the plurality of reference estimated classification results output from the plurality of reference classification models.

9. The device of claim 5, wherein the intermediate information comprises a first number of model votes for a first channel category and a second number of model votes for a second channel category by the classification model based on the channel measurement information, and the estimated classification result is determined based on the first number and the second number; and
wherein determining the uncertainty level of the estimated classification result comprises:
determining a degree of difference between the first number for the first channel category and the second number for the second channel category, and
determining the uncertainty level based on the degree of difference.

10. The device of claim 1, wherein obtaining the ground-truth classification result comprises:
causing a positioning reference device to perform classification labelling for the channel measurement information at a location associated with the communication channel; and
receiving the ground-truth classification result from the positioning reference device.

11. The device of claim 1, wherein the estimated classification result indicates whether the communication channel is classified as a line-of-sight channel or a non-line-of-sight channel.

12. The device according to claim 1, wherein the device comprises a terminal device or a location management function.

13. A method comprising:
determining an importance level of channel measurement information about a communication channel for updating a classification model, the classification model configured to determine an estimated classification result of the communication channel based on the channel measurement information;
in accordance with a determination that the importance level of the channel measurement information exceeds an importance threshold for the classification model, obtaining a ground-truth classification result for the communication channel; and
causing the classification model to be updated based at least in part on the channel measurement information and the ground-truth classification result.

14.-17. (canceled)

18. The method of claim 17, wherein determining the uncertainty level of the estimated classification result comprises:
in accordance with a determination that the classification model is a deep neural network, generating a plurality of reference classification models by applying random neural connection dropout on the classification model;
determining, using the plurality of reference classification models, a plurality of reference estimated classification results based on the intermediate information; and
determining the uncertainty level based on a variance of the plurality of reference classification results.

19. The method of claim 18, wherein the classification model comprises a first model part and a second model part connected to the first model part, and wherein generating the plurality of reference classification models comprises:
generating the plurality of reference classification models by applying random neural connection dropout on the second model part of the classification model.

20. The method of claim 19, wherein the intermediate information comprises feature information extracted by the first model part of the classification model from the channel measurement information; and
wherein determining the plurality of reference estimated classification results comprises:
applying the feature information as input to the plurality of reference classification models, and
obtaining the plurality of reference estimated classification results output from the plurality of reference classification models.

21. The method of claim 17, wherein the intermediate information comprises a first number of model votes for a first channel category and a second number of model votes for a second channel category by the classification model based on the channel measurement information, and the estimated classification result is determined based on the first number and the second number; and
wherein determining the uncertainty level of the estimated classification result comprises:
determining a degree of difference between the first number for the first channel category and the second number for the second channel category, and
determining the uncertainty level based on the degree of difference.

22. The method of claim 13, wherein obtaining the ground-truth classification result comprises:
causing a positioning reference device to perform classification labelling for the channel measurement information at a location associated with the communication channel; and
receiving the ground-truth classification result from the positioning reference device.

23. The method of claim 13, wherein the estimated classification result indicates whether the communication channel is classified as a line-of-sight channel or a non-line-of-sight channel.

24. (canceled)

25. A non-transitory computer readable medium comprising instructions stored thereon that, when executed on an apparatus, cause the apparatus at least to perform:
determining an importance level of channel measurement information about a communication channel for updating a classification model, the classification model configured to determine an estimated classification result of the communication channel based on the channel measurement information;
in accordance with a determination that the importance level of the channel measurement information exceeds an importance threshold for the classification model, obtaining a ground-truth classification result for the communication channel; and
causing the classification model to be updated based at least in part on the channel measurement information and the ground-truth classification result.
